(19) United States
(12) Patent Application Publication
(10) Pub. No.: US 2008/0197971 A1
(43) Pub. Date: Aug. 21, 2008

(54) System, method and article for online fraudulent schemes prevention

(76) Inventors: Avraham Elarar, Montreal (CA); Igal Roytblat, Richmond Hill (CA); Moshe Ben-Shlomo, Vancouver (CA)

Correspondence Address: Moshe Ben-Shlomo, 2925 W 42 Ave, Vancouver, BC, V6N3G8, omitted

(21) Appl. No.: 11/707,032

(22) Filed: Feb. 16, 2007

(51) Int. Cl. G06F 7/04

(52) U.S. Cl. 340/5.81

(57) ABSTRACT

A method, system and scheme are presented that provide a means of establishing secure and reliable two-way authentication with online service providers (“Providers”) using a hardware device. The account holders (“Users”) use a unique hardware device (“Hardware Device”), which is plugged into the communication technology, such as computer, being used to access online accounts. The device is used for storing cryptographic algorithms and keys that are capable of performing hashing, encryption and decryption operations. The device is periodically refreshed with new keys, which cannot be read or duplicated by the User.

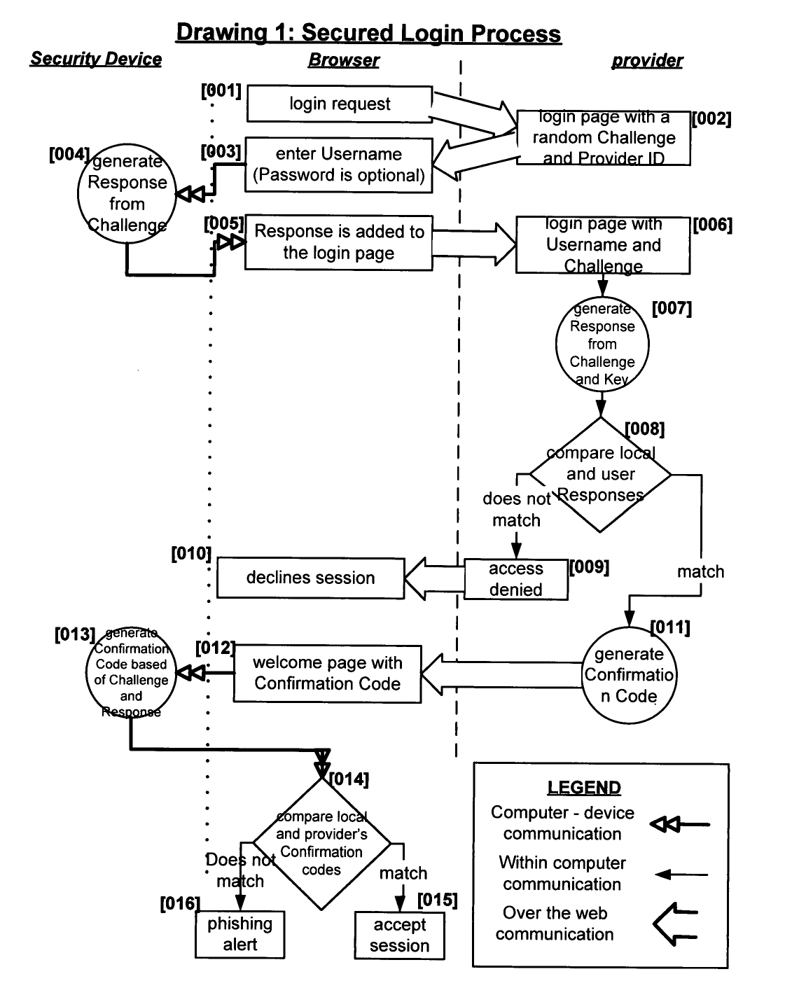

### BACKGROUND OF THE INVENTION

With the rise in popularity of the internet, more service providers are offering consumers the opportunity to conduct business online. Managing bank accounts, shopping for retail items, and interactive gaming are just a few of the many examples of circumstances in which individuals use the internet to perform tasks that were once done strictly in person. An important implication of this fact is that service providers require some reliable means of identifying clients and authenticating their identity prior to allowing access to private or confidential information. Most often access control is attained through the use of login names and passwords. These identifiers can be assigned by the Provider or user-created, but in either case the client needs to remember them in order to access their accounts online.

The present invention represents a considerable security advantage for Providers who pay the cost of internet fraud. Rather than requiring only two pieces of information (i.e. login name and password) to authenticate access requests, the present invention makes it substantially more difficult to obtain fraudulent access. This is so because access requires the User to have possession of the Hardware Device with the most recently updated keys installed to access accounts. Moreover, if the Hardware device was compromised and duplicated in some way, the system will be able to recognize and alert the User of such security breach.

In addition, Users are protected from another increasingly common trend in internet fraud—phishing and pharming. In this scheme, fraudulent communications from those representing themselves as Providers arrive to Users requesting updated information or redirect the traffic to fake websites. Users are prompted to enter their Usernames and Passwords, and unwittingly provide the fraudsters with the information needed to perpetrate further theft and fraud. The current invention makes this scheme difficult because instead of password the device is challenged periodically with random nonces. Based on device's response to the challenge, access may be either granted or denied. The system will raise an alert when a confirmation is not received from the Provider at login. Thus, increased security is achieved for all parties engaging in online account management using the present invention.

Also, there is a security concern when consumers have many different accounts with different service providers. Login names and passwords are often saved in files on computer memory drives or paper notes; in the alternative, consumers may have trouble remembering all their different login names and passwords to the various accounts they manage online. An object of the present invention is to provide consumers with a login mechanism contained in a hardware device carried with them that would dispense with the need to remember passwords for multiple accounts.

### BRIEF DESCRIPTION OF THE INVENTION

The invention is a scheme for authenticating access requests to online accounts that replaces passwords with a Hardware Device containing an embedded encryption algorithm and identification keys. The identification keys are updated at a specified frequency through unique links to the Company or Provider website. Users are notified of these links through specified channels of communication, such as email. Login requests are challenged by the Provider website through the standard CHAP protocol. The Hardware Device responds to the challenge using the identification key associated with that provider to obtain access. A confirmation message is transmitted to the User, indicating that access has been granted. If the confirmation key is not received, the Hardware Device generates a fraud alert to the User.

### DETAILED DESCRIPTION OF THE INVENTION

The invention is a scheme that uses identification keys, provided by either the Provider or a trusted third party (“Company”) to allow two-way authentication for online account access. The system operates in three separate phases: Users' subscription to the service, updating the identification key, and logging onto Providers' websites.

1. Subscription to Service

The first phase of the invention is subscription. Use of the system can be either voluntary on the part of the User or, in the alternative, mandated by the Provider as a necessary security measure. Users subscribe to the service through the either the Provider or the Company website. Upon subscription, the User, Provider or Company specifies the frequency of identification key updates, establishes the User ID and contact information. If this is an initial subscription, the Company (or Provider, as the case may be) associates a Hardware Device with an embedded algorithm and identification key correlated to the User ID. The User may also subscribe to additional Providers using the same Hardware Device associated with a previous subscription. The Company may support multiple devices for a single user.

2. Identification Key Update

The User receives some correspondence (including, but not limited to an email, SMS, phone call or letter) from the Company at the frequency specified upon subscription or other criteria. This message contains a unique link to a Company (and/or Provider) website, which prompts the User to insert the Hardware Device, if not already detected by the system. After User authentication, the Company replaces the identification keys due for update with new ones. After the User or Hardware Device acknowledges completion of the update procedure, the Company/Provider sends the same keys to corresponding Providers associated with that user. The identification keys are not updated until the User acknowledges the notification.

To avoid a situation where the User was already updated and the Provider has not yet registered the new keys, the Hardware Device may keep the old identification keys as well as the new ones and use both. The old keys may be purged after the Provider acknowledges the new keys.

3. Login Request Authentication

When the User accesses the login page on the Provider's website, the Provider will challenge the User with a cryptographic nonce. The Hardware Device responds based on the identification key associated with this Provider (using the standard CHAP process). The response is sent to the Provider to be compared with the expected result based on the identification key associated with the User. If the results match, the Provider sends back a confirmation message, which prompts the Hardware Device to generate a “fraud safe” indication. If the confirmation is not received, or is incorrect, the Hardware Device generates a security warning to alert Users of fraud. The system may support a periodic refresh during session of the acknowledgement process that will in turn refresh the “fraud safe” indication.

Different Providers may require different minimal key refresh intervals or limit Users that do not update keys frequently enough to low risk operations only (like get reports vs. transfer funds).

### Brief description of Secured Login Process (drawing 1)

### Glossary:

Challenge: A random string generated by provider
Confirmation Code: Data generated using challenge, response and key
Key: cryptographic (or other) data used to encrypt, decrypt or sign information
Password: Secret text that may be required by the provider in addition to usemame and response
Provider ID: A unique identifier of a provider
Response: A cryptographic operation using a challenge and a key associated with the provider
Security Device: secure hardware apparatus (such as USB) used to generate responses to challenges
Username: A unique user identifier associated with the provider's site. A specific user may have different usernames for different providers

### Sequence:

User calls up login page via an Internet browser

provider loads the login page with a random challenge and provider's ID

user enters username (and password, if applicable)

security device generates a response using the challenge sent by the provider and a key associated with the provider's ED (stored in the security device)

response is added to the login page (automatically or manually)

provider receives username and response (and password, if applicable)

provider generates local response using challenge and key associated with the specific user (stored in secure database on provider's site)

provider compares local and user responses

if responses do not match—provider blocks access

user's request for session declined

if responses match, provider generates confirmation code

user receives welcome page with confirmation code

security device generates confirmation code based on challenge and response.

user's computer compares confirmation codes

if confirmation codes match: session starts

if confirmation codes do not match security device generates a phishing alert

What is claimed:

1. A system, scheme and method of user authentication for access to secure online accounts comprising:
A unique Hardware Device that contains an encryption algorithm and set of identification keys used to generate login credentials based on one time challenge messages;
The assignment of temporary identification keys by the Company on a predetermined or other frequency;
A verification by the Provider of the login credentials based on standard CHAP protocol;
The transmission from the Provider of a confirmation message in the absence of which the system issues a potential fraud warning.

2. A system, method and scheme of claim 1 whereby the temporary identification key is loaded into the Hardware Device when the User responds to a notification message sent through predefined communication channels.

3. A system and method of claim 2 wherein the updated identification key is activated upon acknowledgement by the User.

4. A system, method and scheme of claim 2 wherein the updated identification key is transmitted to the Provider when the User acknowledges Hardware Device update.

5. A system, method and scheme of claim 1 wherein the identification keys are inaccessible and unusable by other then the Hardware Device.

6. A system, method and scheme of claim 1 whereby the login page of the Provider website transmits a challenge message, to which the Hardware Device generates a response, based on identification key associated with the Provider.

7. A system, method and scheme of claim 1 wherein the confirmation message is verified by the Hardware Device to authenticate the identity of the Provider.

8. A system, method and scheme of claim 7 wherein the Hardware Device generates a security alert if the confirmation key either fails to arrive or is incorrect.

9. An alternative system, method and scheme of claim 1 wherein the Company assigns the identification key and acts as Provider.
